(19) United States
(12) Patent Application Publication
(10) Pub. No.: US 2011/0190123 A1
(43) Pub. Date: Aug. 4, 2011

(54) SLOW-RELEASE FORMULATIONS CONTAINING QUILLAY EXTRACTS, FOR CONTROLLING WHEAT TAKE-ALL DISEASE

(76) Inventors: Gaston Eduardo Apablaza Hidalgo, Santiago (CL); Ernesto Antonio Moya Elizondo, Region del Libertador Bdo. O'Higgins (CL); Guillermo Aguiar Méndez, Santiago (CU)

(21) Appl. No.: 13/001,352

(22) PCT Filed: Jun. 26, 2009
(86) PCT No.: PCT/CL2009/000003

§ 371 Date: Apr. 20, 2011

(30) Foreign Application Priority Data
Jun. 27, 2008 (CL) 1927-2008

(51) Int. Cl. C05G 3/00; A01N 45/00; A01P 3/00; C05G 3/02; B29B 9/02

(52) U.S. Cl. 504/101; 514/26; 264/141

(57) ABSTRACT

This invention refers to natural fungicide used in the treatment of seeds or soil treatment, that were obtained from the formulation of quillay extracts, rich in saponin concentrations, to which synthetic polymers (latex and resins) were added allowing its slow release on the soil, and which control efficiency was proven on the Gaeumannomyces graminis fungus, which is the cause of the take-all of wheat at experimental plant pot and field level.

### DESCRIPTION OF THE INVENTION

1. Background of the Invention

Slow release quillay extract-based natural fungicides for control of take-all disease of wheat.

2. Summary of the Invention

This invention refers to natural fungicides used in seed treatment or soil treatment, that are obtained from quillay extract formulation, rich in saponin concentrations, to which synthetic polymers have been adhered (latex and resins) allowing its slow release in the soil, and which efficiency and control have been tested at a plant pot and field experiment level on fungus Gaeumannomyces graminis, which is the cause of take-all of wheat. Experiments conducted in plant pots have shown control effects of developed formulations, while field tests conducted in Region IX of Chile, aimed at demonstrating its effectiveness, shown that in spite of not observing that tested quillay formulations were able to reduce root rot in wheat plants, due to the highly rainy climate conditions of the season when experiments were conducted, and to the fact that commercial fungicide Latitude® (e.g., Silthiofam, Monsanto), added as a reference product in all the field tests, did not show effectiveness in any of the four field experiments. Therefore, it seems reasonably to state that lack of effect shown by the different assessed formulations in inhibiting early development of the infection does not necessarily obey to little or nil effectiveness of the same, but to the intervention of other factors that could have neutralized such characteristic.

These products are important because there are not compounds of natural origin currently used to control fungus Gaeumannomyces graminis, and commercially available chemicals are not able to effectively control this disease.

In view of this situation, and thanks to the financial support provided by COPEC-UC foundation, different quillay extract-based natural fungicide formulations have been developed. Those fungicides have shown interesting control levels, and they could become low cost, biological, and environmentally sustainable alternatives to control take-all disease of wheat.

3. Prior Art

Take-all disease is important worldwide, and it represents $5,000 million Pesos per year in Chile in economic terms, concentrating its losses in IX Region, where 10% losses in performance may be moderately observed, implying estimated losses amounting to $2,400 million Pesos at a regional level. In addition, little crop substitution alternatives in the affected zone and decreased canola seeding allow foreseeing an increase in this disease over the next years.

Absence of effective chemical control methods against wheat root rot has been a frustration for decades (Hornby, 2003). Some applications of certain fungicides applied as seed treatments have recently favored decrease in take-all disease (Jenkyn, et al. 2000), but have not been fully effective. Although silthiofam and triticonazole-based chemicals recommended for control of “take-all disease” have shown higher efficiency over the last years, they are also very expensive.

Studies with quillay extracts have allowed developing natural products with action against Botrytis, Eryshipe, and Blumeria (Apablaza et al., 2002; Moya, 2003; Villegas, 1999). In addition, microscopy studies through histological techniques allowed observing affected and/or totally disorganized conidiophores, and conidia lysed, supporting the control effect of a quillay extract on oidium (Apablaza et al, 2004).

In this context, there is significant interest in the importance of saponins present in oat root, because they determine oat resistance to infections caused by the fungus that causes “take-all disease” (Turner, 1953; Osbourn, 1996a; Papadopoulou et al., 1999). The possibility of being able to use plant extracts rich in saponins obtained from quillay has given the chance of using them in control of fungal diseases; and in this particular case, it has allowed investigating effects of saponins on the fungus Gaeumannomyces graminis, becoming an control alternative that has not been thoroughly studied, and on which the Crop Pathology Laboratory team at the Pontificia Universidad Católica has been a pioneer in developing formulations using natural quillay extracts, which have special release characteristics.

Researches conducted within the framework of a project COPEC-UC has determined control effectiveness of quillay saponins in concentrations greater than or equal to 100 ppm in the culture medium, and a fungistatic effect of lower saponin concentrations, under in vitro conditions. As in the case of oidium, optical and electronic microscopy studies allowed observing a lysis effect and disorganization of quillay extracts on Gaeumannomyces graminis rhizoids (see FIG. 1). Control response curves to different saponin concentrations in culture medium have also been established for different fungus isolations and with different products extracted from quillay. In addition, and in spite of variability in results obtained in experiments conducted in plant pots, formulations SRL 14 (product for soil treatment), and SRL 25 (product for seed treatment) have shown the best results with control levels similar to such obtained using the commercial product Latitude® (e.g., Silthiofam). These are the treatments having highest commercial and patenting projections from the 68 formulations and variants thereof that have been manufactured by us. Finally, conducted works have allowed demonstrating saponin retention levels in the soil from 53 to 89%, evidencing high viability of saponinic triterpenes in the soil (Saquimux, 2007).

During 2004, a search in European Office, American Office, and Spanish Office patent databases, and in Industry Property Department national databases was conducted to determine patent alternatives connected to the use of quillay saponins in formulations for control of fungus Gaeumannomyces graminis. This search determined that there is not background information regarding this topic that could influence obtaining a patent in the future. Added to the foregoing, the investigation conducted corresponds to the first attempts aimed at developing a product derived from quillay saponins allowing control of this pathogen, and that the few studies regarding this subject have been carried out by the leaders of this project.

In view of the foregoing, the possibility of patenting this quillay extract-based natural fungicide that may be used to control fungi as a seed treatment or as a soil treatment, is high, since there are the following patents at an international level: U.S. Pat. No. 6,482,770: inventors: Dutcheshen, J., and Danyluk T. “Method and composition for protecting plants from disease”; U.S. Pat. No. 5,639,794: inventors: Emerson, R.; Crandall, Jr., and Bradford G. “Use of saponin in methods and compositions for pathogen control; US2006/0121126 inventors: Peters, Verny, Jones, Schmith & Aston: “Environmentally Friendly pesticide and method of use”) concerning use of saponins as agents allowing control of fungi.

The problem solved by this invention through these natural fungicides consists of offering potentially commercial products, which are environmentally friendly, and have high marketing potential considering new trends to healthy and agrochemicals free food. For example, consumer's response to this new trend may be reflected in development of organic crop agriculture in the United States. This activity usually occupies 350,000 ha, of which around 56,750 are dedicated to organic wheat crop. Sales obtained in organic outlets reached US$ 7.8 billion in the year 2000 and have experienced a 25% annual growth over the last ten years, a trend that is likely to continue growing around the world (Greene and Dobbs, 2001). A control alternative has thus been developed for wheat root rot that is based on a natural molecule, such as, Quillay saponins that can be used in traditional productive exploitations, which do not have a proper control system for this disease, and for organic type productions, considering that use of quillay saponins has been certified for organic production.

It is also necessary to note that these consumer's trends are becoming specific actions, such as, programs aimed at reducing use of pesticides in agricultural crops being developed in the United States and Europe. For example, the Pesticide Action Network (PAN) of Germany and the United Kingdom is financing researches with natural microorganisms or compounds controlling crop diseases and intended to replace use of dangerous pesticides with ecological alternatives. It is also expected that crop producers, food companies, and governments implement specific actions for pesticide reduction within productive chains on a step by step basis. This situation suggests that similar actions should be established in Chile in the future, since this kind of actions may be used to establish para-tariff actions reducing trade among countries, and affecting other export areas developed in Chile.

As an after-effect, these inventions allow enlarging trade possibilities for quillay extracts, which have already been successfully used in agriculture as a product applied to soil. This is the case of the product QL Agri 35, which is a 100% natural origin nematicide specially indicated for nematode control in vines and citruses. Due to its natural product characteristics, this product is especially suitable to become part of the Integrated Management Programs, and is certified to be used in organic productions, just like its production process, that received a Merit Mention in the National Award to Agricultural Innovation in 1999, and that was patented.

In addition, developed formulations will be less expensive than chemical treatments available in the market, reason why they can become a treatment alternative for traditional farmers.

The promoting bacteria growth characteristic showed by quillay saponins, has been described by Sen, et al (1998) in his article “Effect of Quillaja saponaria saponins and Yucca schidigera plant extract on growth of Escherichia coli” (Letters in Applied Microbiology 27 (1), 35-38), also poses the question about integrated use of this product with “Plant Growth Promoter Rhizobacteria” (PGPR), as Pseudomonas fluorescens 2-79. This bacterium (P. flourescens 2-79) has been described as Ggt controllers and that live in wheat rhizosphere. This saponin characteristic is also likely to allow keeping suppressive bacteria population for a longer period in Ggt suppressive soils.

Considering that this invention has developed natural fungicide formulations from quillay saponins, its development features the following advantages:

They are products that could be a more natural alternative to control the take-all disease of wheat due to the lack of alternatives currently existing and to the fact that their closest competitors have not shown fully satisfactory results.

They are products that could be part of integrated plague management programs, because, as natural products, they could reduce the pressure of using agrochemicals or could improve control effect of other Ggt's antagonist microorganisms.

They are relatively low cost products compared to their competitors. Fox example, distributor price of Silthiofam is US$ 66 per liter, while SRL 25 Dust based on powder quillay extract QP 1000 would cost around US$ 8.1 per kg.

The possibility of obtaining a proper raw material supply to meet both local and international market requirements is real because quillay is an endemic species of Chile. There is an installed production capacity that is able to ensure such supply because quillay trees are adapted to agricultural-climatic conditions of Chile. Moreover, advanced researches concerning to the sustainable production, according to which it would only be necessary to commercially produce around 3000 ha.

### BRIEF DESCRIPTION OF THE FIGURES

FIG. 1 Microscopic observation (100×). Gaeumannomyces graminis var tritici without application of saponins (left) and with application of 200 ppm of saponins (right).

It is possible to observe the direct effect of fungus Gaeumannomyces graminis var tritici on the mycelium without application of saponins and with application of 200 ppm of saponins (Microscopic observation (100×)).

FIG. 2 Results of infection according to the Take-All Disease Index (TAI) obtained in the evaluation of quillay extract-based slow release formulations with regard to a commercial sample (Latitude®, i.e. Silthiofam, Monsanto), a non-inoculated sample (s/i) and an inoculated sample (c/i). Green columns show the best treatments.

FIG. 3 Results of infection according to Take-All Disease Index (TAI) obtained in evaluation of different dosages of SRL 14, sawdust fortified with quillay extract, and QL 1000 as a seed treatment in comparison to a commercial sample (Latitude® i.e., Silthiofam, Monsanto), a non-inoculated sample (s/i), and an inoculated sample (c/i). Green columns show the best treatments.

FIG. 4 Results of the evaluation of control effect of SRL 25, SRL 70 GIB, and different dosages of SRL 14 on Ggt in wheat in comparison to a commercial sample (Latitude® i.e., Silthiofam, Monsanto), a non-inoculated sample (s/i), and an inoculated sample (c/i). Seeding date: Mar. 23, 2005. Green columns show the best treatments.

FIG. 5 Results of infection according to the Take-All Disease Index (TAI) obtained in the evaluation of different slow release formulations in comparison to a commercial sample (Latitude® i.e., Silthiofam, Monsanto), a non-inoculated sample (s/i), and an inoculated sample (c/i). Seeding date Mar. 30, 2005. Green columns show the best treatments.

FIG. 6 Results of the experiment aimed at evaluating slow release “Plus type” quillay extract-based formulations (with addition of fertilizers and plant hormones) in comparison to SRL 25, SRL 49, a commercial sample (Latitude® i.e., Silthiofam, Monsanto), a non-inoculated sample (s/i), and an inoculated sample (c/i). Seeding date: Oct. 3, 2005. Green columns show the best treatments.

FIG. 7 Result of infection according to the Take-All Disease Index (TAI) used to assess the effect of different concentrations of saponins present in quillay extracts QL 1000 used to manufacture SRL 25 formulations. Concentrations of saponins present in QL 1000 used in preparation of SRL 25 are shown in brackets.

FIG. 8 Curve adjustments for the first assessment of saponin percolation from treated seeds through measurement of foam height during 16 wash cycles in quartz percolation columns.

FIG. 9 Curve adjustments for the second assessment of saponin percolation from treated seeds through measurement of foam height during 16 wash cycles in quartz percolation columns.

FIG. 10 Observation of mycelium treated with a dose of 0, 50, 100 and 500 ppm of saponins. Hypha deformation is observed in Ggt mycelium, and broken connector membranes of mycelial strands between fungus hyphae.

FIG. 11 Magnifying 15,000 times the Ggt mycelium treated with a dose of 50 ppm saponins, observing hypha deformation and mycelium thinning in Ggt mycelium, and mycelium treated with a dose of 100 ppm saponins where hyphae showed broken connector membranes of mycelial strands between Ggt hyphae.

### DETAILED DESCRIPTION OF THE INVENTION

The invention essentially corresponds to six formulations. Two formulations of SRL 25, which is an oven-dried mixture of latex plus extract QL 1000, and its variant SRL 25 Dust using QP 1000, corresponding to spray-dried QL 1000 in powder. SRL Plus formulation corresponds to the same formulation as SRL 25, but with additions of plant hormones (indole butyric acid) and fertilizers (nitrogen, phosphorus, and potassium). The fourth product of this group, SRL VAX Plus, corresponds to the mixture of Vax Sap (formulation in powder with 83% quillay saponins) with latex, plus the additions above described in SRL Plus. The last products correspond to two formulations used as treatments applied to the soil that are a powdered quillay extract-based formulation mixed with a polymer—urea formaldehyde—(SRL 14) and another granule or pellet formulation in a mixture of latex with bentonite clay (SRL 14B Gran). All these formulations correspond to quillay extract-based natural fungicide for control of take-all disease of wheat having such a conformation allowing slow release of quillay saponins in the soil.

Formulations SRL 25, SRL 25 Dust, SRL Plus, and SRL VAX Plus are liquid concentrated suspensions used as a seed treatment.

SRL 25 has 3.85% saponins in suspension, and is obtained through the mixture of 66.19% of latex Mowilith DM 530 (polymeric aqueous dispersion of vinyl acetate and an plasticizer-free acrylic acid esther with a 50% solid concentration) with 17.99% of QL 1000 extract (dark brownish-grey colored, sticky to the touch, slightly caramel scented concentrated Quillay aqueous extract, with a concentration of 42% p/p soluble solids and 9% p/p saponins), oven-dried, and 15.83% water. Drying QL 1000 extract allows concentrating saponins in approximately 21.4% p/p saponins, and this QL 1000 powder is obtained through the following operations:
10 ml of QL 1000 are placed in several Petri plates.
Plates containing QL 1000 are placed in an oven at a regulated temperature of 105+/−1° C. Proper operation of oven thermostat is crucial during this step, because uncontrolled temperature rises could decompose or damage saponins or other products present in QL 1000.
Plates are left in the oven for four hours.
Once the above mentioned period has elapsed, plates are taken out and placed in a dryer hood with silica gel.
Once they are cold, plate solid is detached using a scraper.
QL 1000 powder is crushed in a porcelain mortar until obtaining fine and intangible powder.
This solid is kept in a hermetically closed flask and is placed in a dryer hood with silica gel.

First step to prepare the formulation of SRL 25 consists of weighing the QL1000 powder in a container. Water is then added and ingredients are mixed until all powder is properly wet, but not necessarily dissolved; latex Mowilith DM 530 is then slowly added and stirred using a glass stick. When dried QL 1000 is mixed with latex, saponins precipitate simply because of the change of solvent. This process must be carried out slowly and constantly stirring to avoid formation of solid lumps that could precipitate or separate in phases.

Product proportions needed to prepare 100 g of SRL 25 composition are described below:

SRL-25

| | Mass | Composition | Saponins |
|---|---|---|---|
| Product | (g) | (%) | (%) |
| Dried QL 1000 | 17.99 | 17.99 | 3.85 |
| Latex Mowilith DM 530 | 66.19 | 66.19 | |
| Water | 15.83 | 15.83 | |

SRL 25 Dust has similar saponin content (3.85%) than SRL 25, and follows in turn the same preparation procedure and concentrations of adjuvants of the above described mixture. However, the formulation uses QP 1000 instead of QL 1000 powder. QP 1000 corresponds to a chocolate colored, slightly hygroscopic, fine powder with a concentration of 21.4% p/p saponins that irritates nasal mucous and has high sneezing effects; it is highly water soluble and forms dark and clear dissolutions with water similar to QL 1000. However, QP 1000 is obtained from aqueous quillay extracts that have undergone a spray-drying process so that this powder is made up by solids dissolved in QL 1000. The spray drying process is a technology developed by Natural Response S.A.

Product proportions needed to prepare 100 g of SRL 25 Dust are described herein below:

SRL 25 Dust

| | Mass | Composition | Saponins |
|---|---|---|---|
| Product | (g) | (%) | (%) |
| QP 1000 | 17.99 | 17.99 | 3.85 |
| Latex Mowilith DM 530 | 66.19 | 66.19 | |
| Water | 15.83 | 15.83 | |

QL 1000 dried through the above described procedure and QP 1000 have very different behaviors when added to the polymeric latex. While QL 1000 powder creates stable creamy-looking suspensions, QP 1000 suspensions tend to separate in phases; solids separate and create lumps. In both cases, viscosity increases significantly if suspensions are allowed to settle for a while, but in the case of QL 1000 powder, when the mixture is stirred, it becomes fluid and creamy again, but when QP 1000 is stirred again, liquid separates from solids, making somehow difficult to produce SRL 25 Dust.

SRL Plus has 3.85% saponins, with 17.99% dried QL 1000 or QP1000 extract, 68.92% latex Mowilith DM 530, and a 14.42% water proportion, to which the plant hormone indole butyric acid (IBA) is added in a 100 μM concentration (784 μL of an IBA dissolution at a concentration of 1500 ppm in 65 grams of solution), and fertilizer salts that provide nitrate, phosphate, and potassium. Salts used were potassium dihydrogen phosphate (KH₂PO₄) and potassium nitrate (KNO₃), each applied in a proportion corresponding to 0.86% of the concentrated suspension (approximately 0.5 g per 65 g of the mixture).

Product proportions needed to prepare 65 g of SRL 25 Plus are described herein below:

SRL-25Plus

| | Mass | Composition | Saponins |
|---|---|---|---|
| Product | (g) | (%) | (%) |
| QP 1000 or dried QL 1000 | 10.44 | 17.99 | 3.849 |
| Latex Mowilith DM 530 | 40.00 | 68.92 | |
| Water (this is the water mass where | 7.60 | 13.09 | |
| IBA solution is added (1500 ppm), | | | |
| anti-foaming agent, and fertilizers) | | | |
| KH₂PO₄ | 0.50 | 0.86 | |
| KNO₃ | 0.50 | 0.86 | |
| Water | 5.18 | 10.02 | |
| IBA solution 1500 ppm* | 0.784 | 100 μM | |
| Anti-foaming agent | 1 gota | 0.00 | |
| Powder PR 112 | 0.00 | 0.00 | |

*784 μL of an IBA dissolution at a concentration of 1500 ppm added to the above described water mass.

SRL 25 Plus is prepared according to the following procedure:
KH₂PO₄ and KNO₃ are weighed in containers, and are both mixed in one of the containers, and diluted in a part of the amount of distilled water grams required. Dissolution process is accelerated when putting the container in hot water.
Once completed, the dissolution is allowed to cool down.
A drop of anti-foaming agent is added.
The necessary amount of 1500 ppm IBA dissolution is added.
It is completed with distilled water until obtaining total water mass needed, which must include the weight of both fertilizer salts.
Required grams of latex Mowilith DM 530 are slowly added to the above mentioned dissolution, while stirring vigorously using a glass stick.
Dried QL1000 or QP1000 is added, mixed, and stirring using the glass stick.
Once the mixture is completed, it must be doughy and may be transferred into hermetically closed containers.

The product SRL VAX Plus is prepared using a similar procedure than for SRL 25 Plus, and contains the same additional ingredients described herein above. The difference is that it uses Vax Sap, which is a powder formulation containing 83% quillay saponins in its formulation, increasing thus saponin concentration to 12.4% in the product. Proportions of each formulation compound are slightly different from such described herein above, SRL VAX Plus uses 14.94% Vax Sap, 69.72% Latex Mowilith DM 530, 15.4% water, which contains the IBA (100 μM) and KH₂PO₄ and KNO₃ in a proportion of 0.97% of total product composition, each.

Vax Sap is a cream-colored very fine powder that is very irritating for nasal mucous and has a high sneezing effect; it is very water soluble and forms clear and transparent dissolutions with water. VaxSap is obtained though successive purification stages of quillay extracts until obtaining an almost white solid having 83% saponins. VaxSap is a high cost product due to this refinement and was used with a comparative rather than commercial interest, since it allowed using almost pure saponins in formulations. Use of Vax Sap allows to obtain formulations with a high polymeric load and higher proportion of saponins.

Product proportions needed to prepare 24 g SRL Vax Plus are described below:

SRL VAX Plus

| | Mass | Composition | Saponins |
|---|---|---|---|
| Product | (g) | (%) | (%) |
| Vax Sap | 3.00 | 14.94 | 12.40 |
| Latex Mowilith DM 530 | 14.00 | 69.72 | |
| Water (this is the water mass with the | 3.08 | 15.34 | |
| IBA solution and the fertilizers) | | | |
| KH₂PO₄ | 0.195 | 0.97 | |
| KNO₃ | 0.195 | 0.97 | |
| Water | 2.69 | | |
| 1500 ppm IBA solution* | 271 | 100 μM | |
| Anti-foaming agent | 0 | | |
| Powder PR 112 Colouring Agent | 0.00 | 0.00 | |

*271 μL of an IBA dissolution at a concentration of 1500 ppm added to the water mass described herein above.

The three mentioned quillay extracts (QL 1000, QP 1000, and Vax Sap) are produced by Natural Response S.A. and marketed by Desert King Chile.

Soil application products correspond to SRL 14 and SRL 14B Gran. SRL 14 is a powder formulation with 6.92% saponins, which is obtained through combination of 76.92% quillay extracts QL1000 that are mixed with 19.23% urea formaldehyde polymer, and 3.85% ammonium chloride. SRL 14 has low stability over time because QL 1000 has low pH, causing urea formaldehyde resin cross-linking. 24 hours after preparation, the formulation is observed as a soft gelatinous gel. This gel is easily crumbled in a mortar and then is totally cross-linked in the oven at 105° C. to obtain a very hard amber colored powder. Saponin diffusion signs are observed when this solid is immersed in water; supernatant water becomes colored and foam is formed. Particles do not show a trend to dissolution and stay in the bottom of the container without varying their size after successive water additions during weeks.

The preparation is based on the fact that the urea formaldehyde polymer is very well mixed with QL 1000 and that this polymer, when cross-linking on the air with ammonium chloride, is easily detached from a hard and smooth surface. Cross-linking with ammonium chloride allows obtaining harder, more resistant and brittle cross-linking. Preparation of SRL 14 consists of mixing urea formaldehyde polymer with QL 1000 and ammonium chloride in the already described proportions. This mixture is oven-dried at a temperature of 105° C., where it is allowed cross-linking for 72 hours. When the product is finally dried, it is grinded with a mortar.

Product proportions needed to prepare 26 g of SRL 14 are described below:

SRL-14 (Powder)

| | Mass | Composition |
|---|---|---|
| Product | (g) | (%) |
| Urea Formaldehyde Resin | 5 | 19.23 |
| QL 1000 | 20 | 76.92 |
| Ammonium Chloride | 1 | 3.85 |

SRL 14 generates a very hard powder since it is based on the need of thermosetting resin that requires a crushing operation that could not be implemented using the resources available to the project, and the Laboratory, in addition to the difficulty of obtaining the urea formaldehyde, prevented us from continuing manufacturing the SRL 14, in spite of the good results obtained in plant pots.

SRL 14B Gran is a pellet or granule-shaped solid formulation that uses latex Mowilith DM 530 as a binding agent, a suspension of 140 g·L⁻¹ concentration bentonite and kaolin as a filler, as well as KH₂PO₄ and KNO₃ as fertilizers. The formulation looks like a plastic dough very similar to play dough or clay. This mixture is extruded in an empty plastic tube; the mixture is place inside such tube and is pushed by a plunger to a 2 mm diameter nozzle allowing to obtain a 2 mm diameter tubular shaped mold that is placed on a clean metallic surface for being subsequently dried in an oven at 95° C. for 24 hours for its final drying and crushing resulting in 2 to 10 mm long small pellets.

Formulation composition needed to prepare 108.6 g of SRL 14B Gran dry dough is described below:

| | | Mass in | % in | % |
|---|---|---|---|---|
| Product | Product Mass | dry film | dry mass | Saponins |
| Bentonite (suspension | 100.00 | 14.00 | 12.89 | |
| 140 g · L⁻¹) | | | | |
| QL1000 | 60.90 | 25.58 | 23.56 | n/d* |
| QP1000 | 5.00 | 5.00 | 4.60 | 6.03 |
| KNO₃ | 2.00 | 2.00 | 1.84 | |
| KH₂PO₄ | 2.00 | 2.00 | 1.84 | |
| Kaolin | 10.00 | 10.00 | 9.21 | |
| Latex Mowilith DM | 100.00 | 50.00 | 46.05 | |
| 530 | | | | |

*n/d: quillay saponin concentration or percentage was not determined for this compound.

The procedure followed to obtain SRL 14B Gran was as follows:
Weight 2 L 140 g of Bentonite in a container.
Complete with distilled water to a total mass of one kilogram.
Stir the mixture of Bentonite and water
Let the mixture stand during three days. Stir vigorously from time to time using a glass stick.
Filter through gauze when Bentonite is fully wet.
Weight latex Mowilith DM 530 in a 2 Liter container.
Add latex Mowilith DM 530 to the mass of hydrated bentonite suspension
Mix thoroughly to form a mud.
Weight potassium nitrate and potassium di-hydrogen phosphate in small beakers each.
QL 1000 is weighted in a proper container.
Dissolve heavy fertilizers of paragraph 9 with a small quantity of QL 1000.
Add QL 1000 slowly with the other additives to the mud formed by the latex and Bentonite.
Add the QP 1000 mass
Add the Kaolin mass.
Stir constantly to homogenize properly.
Place the mass in the extruding equipment.
Apply pressure to the extruder and pick cylindrical molds from their end up in clean metal trays.
Let molds dry in air overnight.
Place Zinc trays on a regulated stove at a temperature of 80° C.
Increase stove temperature to 105° C. during two hours when molds are dry,
Remove molds from stove and dry in air.
Separate molds from metal or Zinc sheets with a spatula.
Place in plastic vessel.
Cylindrical pellets must be obtained with a length between two to ten millimeters.

Likewise, the invention includes the use of quillay extracts and powders with other substances such as insoluble synthetic polymers in water (latex and resins), salts with fertilizer compounds (potassium, phosphate and nitrogen), natural clays, and vegetal phytohormone, that could be applied to the soil or seeds to control the Gaeumannomyces graminis fungus, in order to ensure the results obtained as product of the work performed in the above mentioned project. It is important to mention that, except for synthetic polymers, the rest of coadyuvants could be considered compounds present in nature.

A description of the coadyuvant compounds used in the elaboration of these formulations is detailed below:
Latex Mowilith DM 530: is a polymeric aqueous dispersion of vinyl acetate and plasticizer-free acrylic acid esther with a 50% solid concentration, which could be qualified as a water insoluble polymer.
Potassium di-hydrogen phosphate (KH₂PO₄) is a soluble salt used as fertilizer, and depending on the dose and application mode as food additive and fungicide.
Potassium nitrate (KNO₃) is a natural salt used as a source of fertilizers.
Indole butyric acid corresponds to a phytohormone similar to plant hormones called auxins.
Urea formaldehyde resin is a thermosetting polymeric resin obtained from urea and formaldehyde. It is a synthetic polymer.
Bentonite ((Na, Ca)_{0.33}(Al,Mg)₂Si₄O₁₀(OH)₂.(H₂O)ₙ) is formed by pure mineral clays used in very fine grain ceramic (colloidal) of montmorilinite type that contains bases and iron.
Kaolin is a pure mineral clay (Al₂Si₂O₅(OH)₄) used in the preparation of porcelain dough and varnishes. It is white.

### Procedure and Evaluation of Formulations Described.

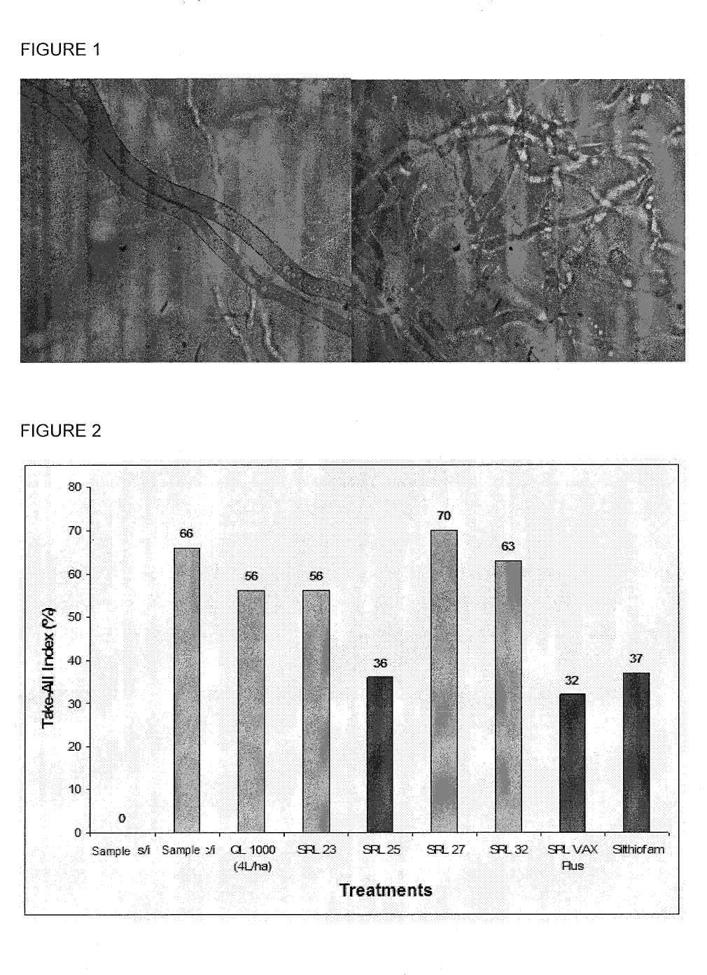

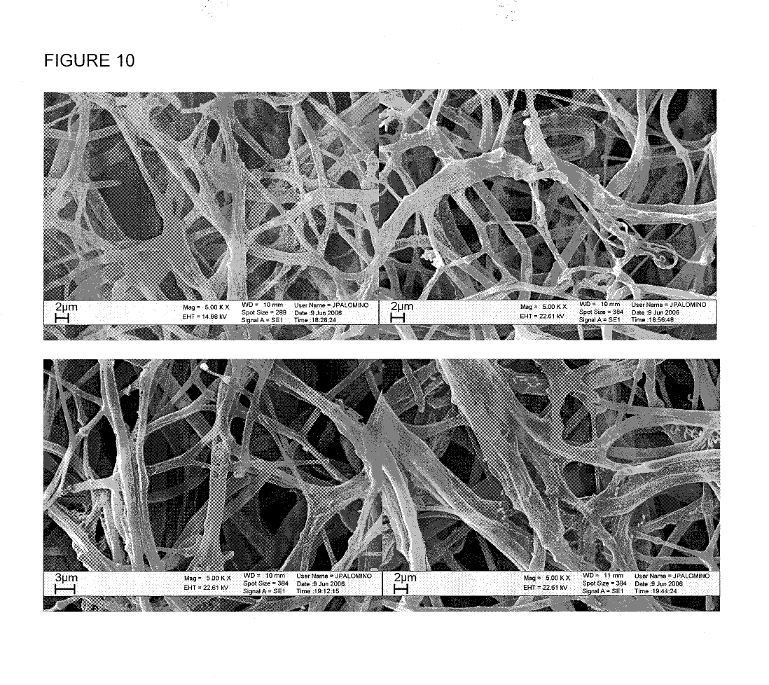

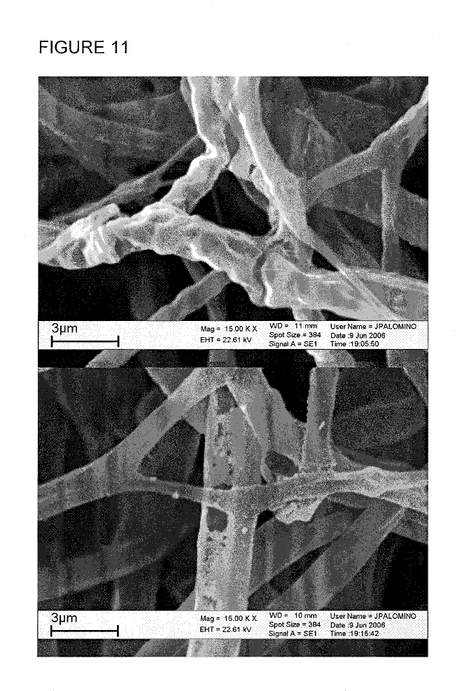

During the development of formulations observation works were conducted through electron microscopy that allowed observing the effect of a quillay extract on the Ggt Mycelium. These measurements allowed to evaluate the effect of the quillay extract application at different saponin concentrations on morphological structures of the fungus and hyphae at increases level of magnifying between 5000 and 15,000 times, and allowed validating the control effect of the active ingredient of the formulations developed. The observational study was conducted through scanning electron microscopy, in the scanning electron microscope of the Faculty of Physics and Agronomy at the Pontificia Universidad Catalica de Chile. This experience allowed observing differences between the dosis of saponin, but not a permanent or continuous damage effect in treatments. Through this microscopy study, it was possible to find effects in membranes tending to generate broken layers that connect to mycelial strands of the fungus at dosis of 100 and 500 ppm of saponins directly applied on the mycelium, which is also confirmed upon observing it under optical microscopy, where dosis effect is more noticeable than when it is performed through electron microscope (FIG. 1). Hyphae deformations were also observed in dosis of 50 ppm in the Ggt mycelium (FIGS. 10 and 11).

Mycelium treated with a dosis of 0, 50, 100 and 500 ppm saponin is observed in FIG. 10. In all these images, it is possible to observe deformation of hyphae in the Ggt mycelium and broken connector membranes of mycelial strands between hyphae of fungus. In FIG. 11 magnifying 15,000 times the Ggt mycelium treated with a dose of 50 ppm saponins, observing hypha deformation and thinning in Ggt mycelium, and broken connector membranes of mycelial strands between Ggt hyphae treated with a dose of 100 ppm saponins.

During the development of the formulations the effect of slow release thereof was also evaluated as well as its residual effect on the soil. During September and November 2005, works tending to develop a methodology that allows the effect of slow release of saponins resulting from quillay extracts used in “Slow release” formulations (slow release coadyuvants), that were used for treating wheat seeds in field experiments performed in the south zone of Chile. Those works consisted in testing the effect of saponin release from wheat seeds treated with quartz percolation columns.

Measurement protocol based on the use quartz percolation columns and the analysis of saponin release from wheat seeds treated with products considered: a system allowing a continuous washing of seeds to imitate climate conditions of the south zone of Chile; an experimental module containing a fastening system of seeds through PVC Columns filled with quartz and a number of seeds treated in the upper part of the column. Additionally, it was provided with a leaching collection system, which was measured through foam height to determine the concentration of the active ingredient and to define the quantity of saponins released from seeds shown by each product after each washing cycle in order to adjust a behaviour curve for each product in time and to make a comparison between them. This experience was repeated twice to validate the results obtained.

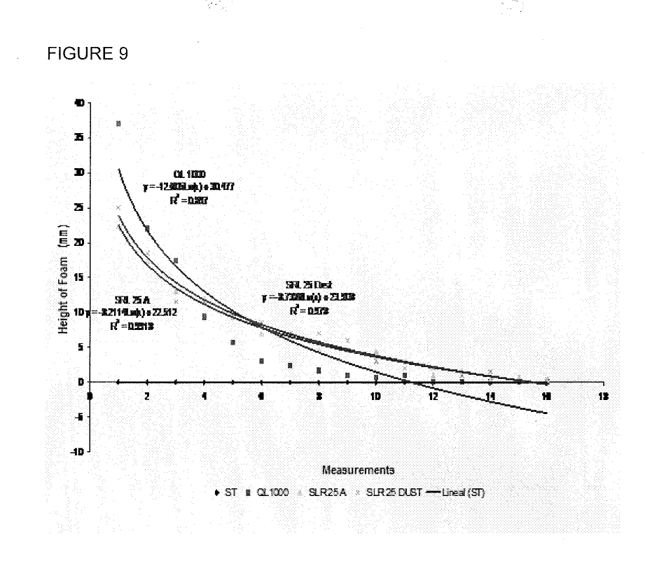

Products evaluated corresponded to a water control and the formulations QL 1000, SRL 25 and SRL 25 Dust, used in a dosis of 450 ppm of saponins per ton of treated seed. The results obtained are shown in FIGS. 8 and 9.

In FIG. 8, curve adjustment is observed for the first saponin percolation behavior assessment experiment from treated seeds through foam height measurement during 16 wash cycles in quartz percolation columns.

In FIG. 9, curve adjustment is observed for the second experiment of saponin percolation behavior assessment from treated seeds through foam height measurement during 16 wash cycles in quartz percolation columns.

In both experiments it was possible to appreciate that SRL 25 and SRL 25 Dust treatments delayed saponin loss process from seeds between 6 and 8 days with respect to QL 1000, in these days there was a breakpoint between the curves elaborated. Likewise, in the first four washes with QL 1000, seeds treated with QL 1000 percolated 74.35% and 84.60% of all saponins detected to each experiment respectively, while SRL 25 percolated 61.50% and 59.32%, and SRL 25 Dust percolated 62.50% and 58.09% to each experiment respectively. In sum, treatments with “slow release” (slow release coadyuvants) allowed to delay saponin delivery from seeds between 12 and 22% more with respect to the use of pure quillay extract applied to the seed during the first four washes of the experiment.

It is necessary to consider that if each quartz column has a 5 cc volume, during four washes it receives 120 ml of water/hour. If this is extrapolated to one hectare with 4,000 m³ soil volume, this would be equal to pass 96,000 liters of water per one hectare/hour.

The statistical analysis to evaluate the difference between the slopes of adjusted curves after transforming data to natural Logarithm allowed to find statistically significant differences (p≦0.05) between both treatment with “Slow release” with respect to sample and QL 1000, in both experiments.

These results allow to state that the base formulation for the slow release where the e.g. quillay extract powders were added that was developed for the SRL 25 and SRL 25 Dust, complies with the effect, giving a matrix where the effectiveness of this characteristic could be evaluated in other fungistatic compounds.

Agronomic evaluation of control effectiveness of the formulations developed on the Ggt fungus was conducted through the establishment of 26 experiments in plant pots. These experiments allowed to evaluate new formulations, or correct defective aspects of the formulations developed. Evaluation methodology was made under greenhouse and awning conditions, considering: soil use of Yerbas Buenas (IX Region VII), which was sterilized by autoclave and inoculated with Ggt grown in oat grains during 40 days. Soil was placed in PVC plant pots arranged on a wooden plate, where it was seeded with a wheat seed of cv. Dalcahue-INIA.

In these experiences two sample treatments were used (with and without inoculum) and one commercial sample Silthiofam (Latitude®, Monsanto) in dosis of 2 L/ton of seed to compare the effectiveness of different slow release formulations or “Slow release” based on quillay extract.

The results obtained in this experience showed that the quillay extract QL 1000 used in pure form as treatment for seeds dis not had a control effect in the dosis of 4 L/ton of seed, which confirms the fact that the treatment of seeds with pure extracts would not be appropriate for the control of the disease. Slow release formulations allowed in some experiences see effects of decrease of value infection determined through the Take-All Disease Index (TAI: Take-all index) for the SRL 25 and SRL VAX Plus, which were close to those obtained through Silthiofam. As observed in FIG. 2, Silthiofam reached 44% of control with respect to the inoculated sample, but the treatment reaching higher control level was the SRL VAX Plus, reaching 52% of control reducing the severity of the disease (FIG. 2); while SRL 25 obtained 45% of control.

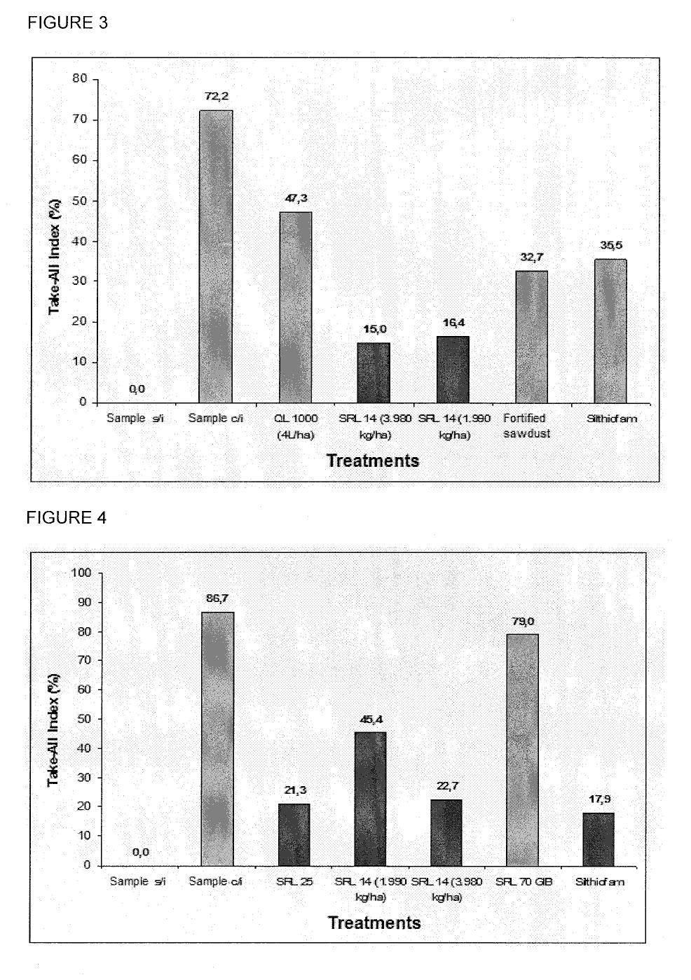

Evaluation of soil treatment with SRL 14, in dosis of 1,990 (0.25 g per plant pot) and 3,980 kg per ha (0.5 g per plant pot), together with quillay fortified sawdust, with extracts of QL 1000 and the seed treatments with QL 1000 in dosis of 4 L per ha and Silthiofam allowed to observe excellent control results for SRL 14 (FIG. 3). Results obtained showed that the commercial sample Silthiofam achieved a control effect of 50.8%, while the use of pure quillay extract reached 34.5% of control with respect to the inoculated sample. The dosis of 0.25 g per plant pot reached control levels of 54.7% for the fortified sawdust and 79.2% for SRL 14, which was the treatment showing lower level of infection and therefore, with higher control effect as it had 57.7% more of effectiveness than the commercial sample. The dosis of 0.5 g per plant pot showed average control results of 72.1% with respect to the sample. These results lead to evaluate formulations for soil treatment that could be used as curative treatment in stable zones where disease spots are present, reducing the Take-All disease incidence in the future.

In general, the results obtained in the experiments performed in plant pots have been variable and in some cases contradictory, but in the experiment evaluating the product SRL 14, product for soil treatment formulated in quillay based powder with compounds of slow release, and SRL 25, product for seed treatment, showed the best results with control levels close to those obtained with the commercial product Latitude® (e.g. Silthiofam, Monsanto). These are the treatments with higher commercial projections among 66 formulations and varieties elaborated thereof. SRL 25 was improved with other compounds (hormones and fertilizers), but in certain experiments it showed contradictory results (FIGS. 4, 5 and 6). The use of the product QP 1000® (Natural Response Ltda.), as active ingredient in the formulations, which is a Spray-dried powder formulation of QL 1000, is considered a factor with influence in these results as better formulations were obtained with liquid QL 1000 dried in stove, while the formulations used with QP 1000 tended to solidify or form lumps.

Best results obtained in the experiments are depicted in FIG. 4, the experiment evaluating the control effect of SRL 25 of quillay, SRL 70 GIB (plus Giberelines), different dosis of SRL 14 of quillay and Silthiofam over Ggt in wheat. In this experiment performed in March 2005, 75.4% of SRL 25 control was observed with respect to the sample, which only varied 4.0% from the control level obtained by Silthiofam in commercial dosis. SRL 14 had a control level almost equal to that obtained by SRL 25 in the dosis of 3,980 kg per ha (0.5 g per plant pot), while the lower dosis had 47.6% of control with respect to the non-treated sample. These results give a strong agronomic and commercial support to the natural fungicide developed.

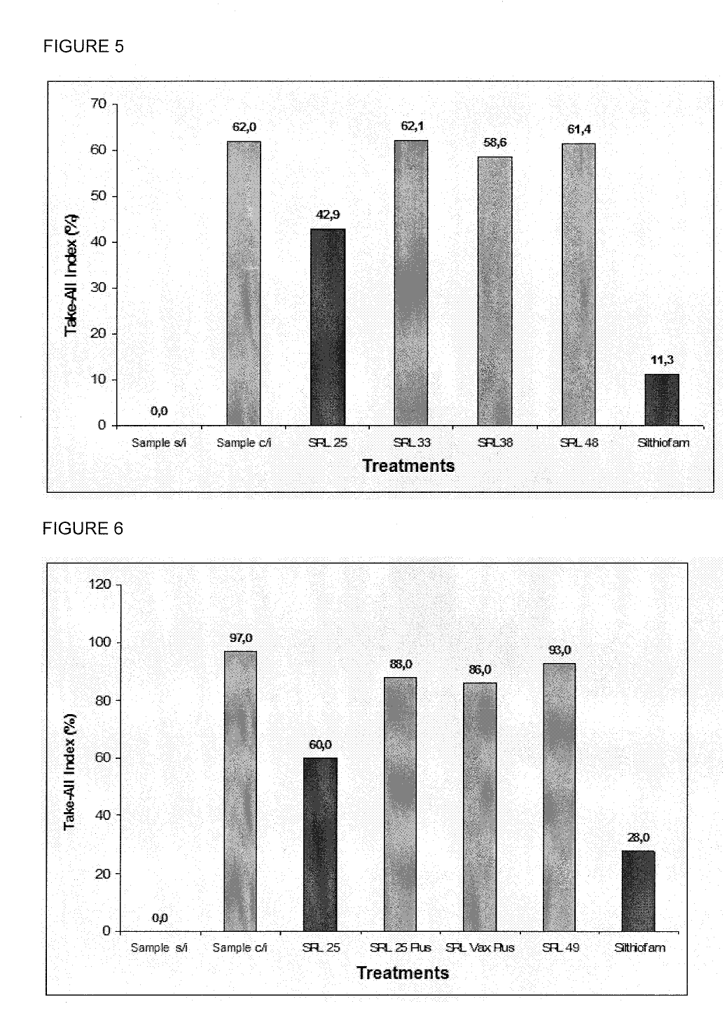

In the FIG. 5 another evaluation of SLR 25 is observed in comparison to other slow release formulations and Silthiofam. This experiment allowed to observe a lower control effect of SRL 25 on Ggt, as it only showed 30.8% of control with respect to the inoculated sample, and a difference of 31.6 percentage points in the Take-All Index with respect to Silthiofam. However, SRL 25 together with Silthiofam in an experiment harvested on Oct. 3, 2005, showed differences with respect to the sample that reached infestation levels in the radicular system higher than 97% as Take-All Index (TAI), while Silthiofam and SRL 25 showed lower infestation levels with TAI of 28 and 60, respectively (FIG. 6). This implies 71% and 38% of control with respect to the non-treated sample, respectively. Likewise, the FIG. 6 describes the evaluation experiment of formulations SRL 25 Plus and SRL VAX Plus, which are slow release quillay extract-based natural fungicides with addition of fertilizers and plant hormones, which did not have a control level that could be agronomically acceptable.

In attention to the variability showed in the experiments with slow release formulations and their control behavior, an evaluation was conducted of some of the possible factors that affect the formulations elaborated, paying special attention to SRL 25 the product showing a more constant efficiency during the experimental work. Thus, during the course of the fourth semester of experimentation (August to September, 2005) 12 formulations of the SRL 25, quillay extract-based QL 1000 were elaborated with different concentrations of saponin and with the addition of compounds that in past experiments showed a decrease in the control level of the SRL 25 product.

Based on this job, it was shown a notorious difference when drying these extracts, for example: if one lot of quillay extract has 10.26% of saponins, this implies that in one kilogram of the product there is 102.6 g of saponins, when drying it, 22.5% of powder saponins are left. The above shows that there are differences between the different lots of dry product ranging between 1.47 to 5.5% in the content of total saponins.

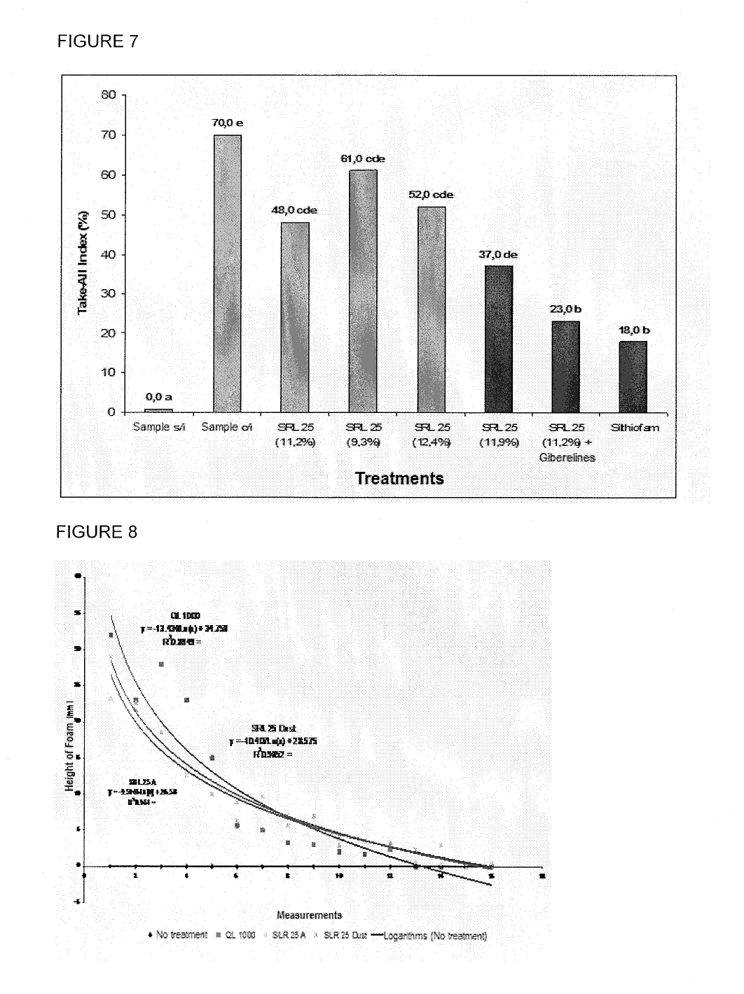

The results of this experience allowed to determine significant differences (p<0.05) in the percentages of infection evaluated among the treatments with respect to the treatment without infection (FIG. 7). From the analysis of results, the SRL 25-elaborated with a quillay extract with 11.2% of saponins p/p, and to which giberelines were added—showed the highest control level within the quillay based products (67.1% of control with respect to the inoculated sample without treatment) not being statistically different to Silthiofam, the sample commercial. SRL 25 formulations without the additive did not showed statistically significant differences with respect to the inoculated sample; notwithstanding the above mentioned, all of them reduced the disease and the SRL 25 elaborated from an extract with 11.2% of saponins was the treatment showing the best control level with respect to the diseased sample (47.1% of control).

These results were not consistent with those obtained in previous experiments, where the formulations with added compounds showed lower infestation levels. A statistical analysis of the SRL 25 formulations without additional compounds showed differences with respect to the inoculated sample, while the SRL 25 with the lowest level of saponins (9.3%) was not different to the inoculated sample and was one of the treatments showing the lowest control level—12.8%. These results confirm the fact that the difference in the content of saponins between other factors associated to extractos has an influence on the formulation and can explain the erratic results observed in some experiments. One more clarifying example corresponds to the Lot 6 of QL 1000 extract, which had 10.26% of saponins and that when being formulated did not allowed an adequate consistency of the products favoring the formation of lumps in the product, reason why it could not be evaluated in plant pot experiments.

Finally and in general, the sample with inoculum showed in average—among all experiences—a level of Take-All Index (TAI) of 75.7, and Silthiofam reached 24.6, SRL 25 reached 38.3 and SRL 14 reached 24.7. These results imply that in average the control level reached with respect to the inoculated sample were 67.5%, 49.4% and 67.3%, respectively. Considering the values obtained through quillay extract-based formulations, they differ from the commercial treatment, but reach acceptable control levels within an agricultural commercial exploitation.

1. Composition destined to the control of the Gaeumannomyces fungus which is the cause of the Take-all of wheat present in the agricultural industry, comprising an active ingredient and synthetic polymers.

2. Composition destined to the control of the Gaeumannomyces fungus which is the cause of the Take-all of wheat present in the agricultural industry, according to claim 1, wherein the active ingredient is a quillay extract.

3. Composition destined to the control of the Gaeumannomyces fungus which is the cause of the Take-all of wheat present in the agricultural industry, according to claim 1, wherein the synthetic polymer is selected from polymeric latex or resins in order to allow a slow release of the active ingredient present in the combination.

4. Composition destined to the control of the Gaeumannomyces fungus which is the cause of the Take-all of wheat present in the agricultural industry, according to claim 3, wherein the synthetic polymer allows to generate an aqueous suspension, a powder, a granule or pellet.

5. Composition destined to the control of the Gaeumannomyces fungus which is the cause of the Take-all of wheat present in the agricultural industry, according to claim 4, wherein the aqueous suspension uses a synthetic polymer consisting of vinyl acetate, an plasticizer-free acrylic acid esther and with a 50% concentration of plasticizers.

6. Composition destined to the control of the Gaeumannomyces fungus which is the cause of the Take-all of wheat present in the agricultural industry, according to claim 1, wherein it uses a quillay extract contributing 3.85% of saponins to the composition in an aqueous suspension.

7. Composition destined to the control of the Gaeumannomyces fungus which is the cause of the Take-all of wheat present in the agricultural industry, according to claim 6, wherein the mixture consists of at least 67% of latex, at least 18% of quillay extract and at least 16% of water.

8. Composition destined to the control of the Gaeumannomyces fungus which is the cause of the Take-all of wheat present in the agricultural industry, according to claims 1 to 6, wherein it additionally comprises fertilizer potassium salts, phosphorus, nitrogen and plant hormones.

9. Composition destined to the control of the Gaeumannomyces fungus which is the cause of the Take-all of wheat present in the agricultural industry, according to claim 8, wherein it optionally comprises plant hormones such as indole butyric acid.

10. Composition destined to the control of the Gaeumannomyces fungus which is the cause of the Take-all of wheat present in the agricultural industry, according to claim 9, wherein it optionally comprises fertilizers that provides nitrate, phosphate and potassium such as potassium di-hydrogen phosphate and potassium nitrate.

11. Composition destined to the control of the Gaeumannomyces fungus which is the cause of the Take-all of wheat present in the agricultural industry, according to claim 10, wherein the fertilizers are applied in a proportion of approximately ranging between 0.50% and 1.00% of the concentrated suspension.

12. Composition destined to the control of the Gaeumannomyces fungus which is the cause of the Take-all of wheat present in the agricultural industry, according to claims 1, 2, 3, 4, 5, 8, 9, 10 and 11, comprising a powder quillay extract with at least 83% of quillay saponins.

13. Composition destined to the control of the Gaeumannomyces fungus which is the cause of the Take-all of wheat present in the agricultural industry, according to claim 12, wherein it uses a quillay extract that provides 12.4% of saponins to the composition.

14. Composition destined to the control of the Gaeumannomyces fungus which is the cause of the Take-all of wheat present in the agricultural industry, according to claims 1, 2, 3, and 4, wherein it is a powder formulation with an urea formaldehyde polymer used as soil treatment.

15. Composition destined to the control of the Gaeumannomyces fungus which is the cause of the Take-all of wheat present in the agricultural industry, according to claim 14, wherein the powder product comprises a thermosetting polymeric resin that is obtained from urea and formaldehyde, which is a plasticizer synthetic polymer.

16. Composition destined to the control of the Gaeumannomyces fungus which is the cause of the Take-all of wheat present in the agricultural industry, according to claim 15, wherein the mixture comprises at least 6.92% of saponins, that are obtained from the combination of at least 76.92% of QL1000 quillay extracts, mixed with at least 19.23% of urea formaldehyde polymer and at least 3.85% of ammonium chloride.

17. Composition destined to the control of the Gaeumannomyces fungus which is the cause of the Take-all of wheat present in the agricultural industry, according to claims 1, 2, 3, 4, 5 and 10, wherein it is a formulation in granules or pellets mixed with a bentonite clay and kaolin and used as soil treatment.

18. Composition destined to the control of the Gaeumannomyces fungus which is the cause of the Take-all of wheat present in the agricultural industry, according to claim 17, wherein the product in granules or pellets consists of at least 46.05% of latex, at least 12.89% bentonite, at least 9.21% kaolin, at least 51.72% of quillay extracts, at least 3.68% of potassium di-hydrogen phosphate and potassium nitrate.

19. Composition called SRL 14 B Gran destined to the control of the Gaeumannomyces fungus which is the cause of the Take-all of wheat present in the agricultural industry, according to claim 18, comprising at least 6.03% of saponins, which are obtained by the combination of at least 23.56% of QL1000 quillay extracts and at least 28.16% of QP 1000.

20. Procedure to prepare a composition destined to the control of the Gaeumannomyces fungus which is the cause of the Take-all of wheat present in the agricultural industry according to claims 1, 7, 11 and 12, comprising the following steps:
a) Weight of quillay extract amount dried in stove or spray in a vessel,
b) Add water as solvent,
c) Mix until powder is wet,
d) Add the synthetic polymer,
e) Mix to precipitate solvents and generate a mixture that should be like an aqueous concentrated suspension, which can be transferred to containers with watertight closing,
f) Optionally, prior to mixture, fertilizer salts and hormones could be added

21. Procedure to prepare a composition destined to the control of the Gaeumannomyces fungus which is the cause of the Take-all of wheat present in the agricultural industry according to claim 20, comprising use of fertilizer salts in stage f) that provide nitrate, phosphate and potassium, as potassium di-hydrogen phosphate and potassium nitrate and traces of plant hormones, such as indole butyric acid, which are dissolved in the amount of water present in the composition.

22. Procedure to prepare a composition destined to the control of the Gaeumannomyces fungus which is the cause of the Take-all of wheat present in the agricultural industry according to claims 1, 13, 14 and 16, comprising the following steps:
a) Weight of quillay extract amount in a vessel,
b) Add water,
c) Mix until powder is wet,
d) Add the urea formaldehyde polymer and ammonium chloride as cross-linking agent,
e) Mix and dry in a stove until it cross links.
f) Grind the product obtained.
g) Transfer the product to containers with watertight closing.

23. Procedure to prepare a composition destined to the control of the Gaeumannomyces fungus which is the cause of the Take-all of wheat present in the agricultural industry according to claims 1 and 18, comprising the following steps:
a) Weight bentonite and settle in water for a while,
b) Filter settled bentonite and mix it with synthetic polymer to form a mud,
c) Weight the quillay extract and mix with the fertilizer salts,
d) Mix the elements described above in b and c, plus kaolin until homogenized,
e) Extrude the mixture through an empty plastic tube in order to generate the pellets or granules,
f) Dry the pellets or granules,
g) Transfer the product to containers with watertight closing.
